(19) United States
(12) Patent Application Publication
(10) Pub. No.: US 2008/0045218 A1
(43) Pub. Date: Feb. 21, 2008

(54) Wireless Communication Terminal and its Control Method

(76) Inventors: Toshio Okochi, Musashino (JP); Yusuke Mishina, Kunitachi (JP)

Correspondence Address: REED SMITH LLP, 3110 FAIRVIEW PARK DRIVE, SUITE 1400, FALLS CHURCH, VA, 22042, US

(21) Appl. No.: 11/793,240

(22) PCT Filed: Dec. 15, 2004
(86) PCT No.: PCT/JP04/19131

§ 371 Date: Jun. 15, 2007

(51) Int. Cl. H04Q 7/20

(52) U.S. Cl. 455/436

(57) ABSTRACT

In the prior art, the initialization process for communication between a wireless communication terminal and a base station is executed by activating the wireless communication terminal with a built-in battery. As a result, the problem is posed that a great amount of power is consumed during the initialization process and the battery of the wireless communication terminal is consumed early. Especially, in the case where the network configuration is required to be changed frequently, the life of the battery of the wireless communication terminal is extremely shortened resulting in a low practical value. In view of this, a passive RFID is mounted on the wireless communication terminal, and the initialization process is executed by the power supplied from the base station using the RFID interface. As a result, the battery consumption of the wireless communication terminal can be prevented in the initialization process.

### TECHNICAL FIELD

This invention relates to a communication technique using a wireless communication terminal, or in particular to a technique for initial configuration process of the communication between the wireless communication terminal and a base station.

### BACKGROUND ART

At the time of the construction and maintenance work for a compact wireless communication terminal used in a communication network using a short-range radio such as the sensor net, the process of registering and initial configuration a new wireless communication terminal including the mutual authentication and the exchange of the encryption keys for communication between a new wireless communication terminal and a base station is required to be executed. This initial configuration process requires the process such as the authentication with a public key cryptography, key exchange, generation of a random number and the write operation into a memory. These processes involve a large amount of arithmetic operation, and therefore, may be difficult to execute for the compact wireless communication terminal operated by the solar battery cell or vibration to electric energy converter. With a wireless communication terminal using a small cell such a button battery cell, on the other hand, the life is extremely shortened, and therefore, the problem of an increased maintenance cost is posed. In the case where the communication between the base station and the wireless communication terminal is initialized using another server, etc. in advance, on the other hand, preparatory operations are required to determine the base station for the destination and distribute the key safely to the particular base station in advance. In view of the fact that the network configuration is generally required to adapt to the situation of the place of installation as occasion demands, however, the aforementioned setting steps lack the operation flexibility and low in working efficiency. Also, in the case where the system configuration for the replacement of a base station is changed due to a fault, the job of recovering and resetting the wireless communication terminal connected to the particular base station is generated.

### DISCLOSURE OF THE INVENTION

(Solving Means)

According to this invention, the aforementioned problem is solved by mounting a passive wireless tag (radio frequency identification; hereinafter referred to as RFID) on a wireless communication terminal and executing the registration and initialization process by the interactive communication between the RFID of the wireless communication terminal and the base station. In this system, power is supplied to the RFID from the base station at the time of registration and initialization, and therefore, the process can be executed without consuming the battery cell of the wireless communication terminal.

Between the wireless communication terminal and the base station, the process of initialization of the communication is executed by communication and power supply using the RFID interface. By supplying power from the base station at the time of initialization in this way, the initialization process using the public key cryptography is made possible even for the small sensor node operated by the button cell or the vibration to electric energy converter. Also, a high durability can be realized even for a wireless communication terminal used under a severe environmental condition for lack of a contact interface.

A specific terminal configuration according to the invention concerns a wireless communication terminal used for a communication system configured of the wireless communication terminal, a base station and a server connected to the base station through a communication network, characterized by a wireless communication function for communication with the base station and a passive wireless tag, wherein the communication between the wireless communication terminal and the base station is set by use of the communication between the passive wireless tag mounted on the wireless communication terminal and the base station.

The terminal is preferably configured to store the information prepared by the process of setting in a memory for conducting the communication. As a specific example, the passive wireless tag may have a nonvolatile storage medium which may record an identification number of the wireless communication terminal and an encryption key unique to the wireless communication terminal. As an alternative, the passive wireless tag may have a volatile memory such as SRAM, in which an identification number of the wireless communication terminal and an encryption key unique to the wireless communication terminal may be stored.

Also, the encryption key unique to the wireless communication terminal may include a public key, a private key and a certificate for authentication by the public key cryptosystem. Further, the encryption key unique to the wireless communication terminal may include an encryption key for the symmetric key cryptosystem. As a wireless communication function, for example, a communication scheme based on a well-known protocol such as wireless LAN can be used.

The wireless communication terminal includes a battery for supplying the operating power. The initialization process is executed by the passive wireless tag receiving the power supplied from the reader/writer of the wireless tag, while the other normal operation is performed by the power supplied from the battery. As a result, the battery power is not consumed for the initialization process which consumes a large power, and therefore, the maintenance intervals or the life of the wireless communication terminal can be lengthened. Further, the result of the initialization process is recorded in the nonvolatile storage medium, and during the normal operation, the result (for example, the identification number of the base station, encryption key for communication, etc.) is read from the nonvolatile storage medium to conduct the communication.

Also, the scope of this invention covers a control method for a communication system configured of a wireless communication terminal, a base station and a server connected with the base station through a communication network, wherein the wireless communication terminal has the wireless communication function for communication with the base station and the passive wireless tag and wherein the process of setting the communication between the wireless communication terminal and the base station is executed using the communication between the passive wireless tag mounted on the wireless communication terminal and the base station.

Further, according to this invention, there is provided a wireless communication system configured of a wireless communication terminal, a base station and a server connected with the base station through a communication network, wherein the wireless communication terminal includes the wireless communication function for communication with the base station and the passive wireless tag, and wherein the process of setting the communication between the wireless communication terminal and the base station is executed using the communication between the passive wireless tag mounted on the wireless communication terminal and the base station, characterized by having the wireless tag read/write function for communication with the passive wireless tag mounted on the wireless communication terminal.

According to another aspect of the invention, a wireless communication terminal, used for a communication system configured of the wireless communication terminal, a base station and a server connected to the base station through a communication network, includes a power supply, a controller, a wireless interface, a nonvolatile memory, an antenna, a RFID unit having a power generating circuit for generating the power from the signal received by the antenna and an internal bus connecting these parts thereby to operate in two modes. In the first mode, used mainly for initialization, the controller is operated with the power generating circuit as a power supply and the result of the operation is stored in a memory such as a nonvolatile memory. During this operation, the power is generated from the signal received by the antenna and used for the controller, the write operation into the memory and the operation of the wireless interface, and therefore, the power supply such as the battery need not be used, thereby leading to the advantage that the restriction of power consumption is not required for the complicated calculations and process (encryption/decryption process and the write operation into the memory) for initialization.

In the second mode, which involves the normal communication operation, the controller is operated using a power supply such as a battery or a small generator, and the communication conducted with the base station through the wireless interface using the information stored in the memory during the first mode. Two controllers including a first controller and a second controller may be provided for the respective modes.

### BRIEF DESCRIPTION OF THE DRAWINGS

FIG. 1 is a block diagram showing the configuration of a communication system including a wireless communication terminal and a base station according to this invention.

FIG. 2 is a configuration diagram showing the contents recorded in a nonvolatile memory in a RFID mounted on a sensor node.

FIG. 3 is a configuration diagram showing the contents recorded in a nonvolatile memory of the base station.

FIG. 4 is a flowchart showing the steps of the initialization process according to the embodiment shown in FIG. 1.

FIG. 5 is a configuration diagram showing the contents recorded in a nonvolatile memory in a RFID mounted on the wireless communication terminal according to a second embodiment of the invention.

FIG. 6 is a configuration diagram showing the contents recorded in a nonvolatile memory of the base station according to the second embodiment of the invention.

FIG. 7 is a flowchart showing the steps of the initialization process according to the second embodiment of the invention.

FIG. 8 is a block diagram showing another example of the configuration of a wireless communication terminal system according to an embodiment of the invention.

### BEST MODE FOR CARRYING OUT THE INVENTION

### Embodiment 1

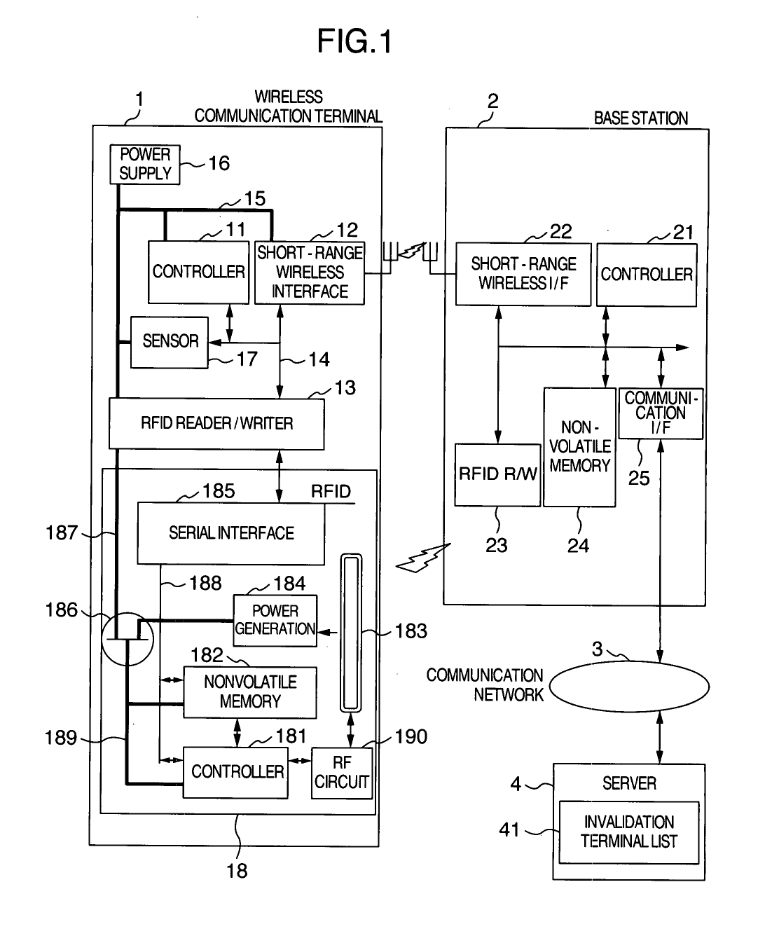

A first embodiment of the invention is explained below with reference to FIGS. 1, 2, 3 and 4.

FIG. 1 is a diagram schematically showing a communication system configured of a wireless communication terminal 1, a base station 2, a communication network 3 and a server 4.

The wireless communication terminal 1 has mounted thereon a controller 11, a short-range wireless interface 12, a sensor 17 and a RFID reader/writer 13, which are interconnected by an internal bus 14. The wireless communication terminal 1 is connected also to a RFID 18 through a RFID reader/writer 13. The RFID 18 has a contact-type interface and a noncontact-type interface. The wireless communication terminal 1 further includes a power supply 16 for supplying power to operate each of the aforementioned parts. The power supply 16, though not specifically limited, is configured of a disposable battery cell such as a button cell or a dry cell, a charge battery such as a lithium-ion cell or a power generating device having a solar cell or a vibration to electric energy converter. The RFID 18 includes a controller 181, a nonvolatile memory 182, an antenna 183, a power generating circuit 184 and a serial interface 185. The RFID 18 further includes a power supply line 187 for supplying power from the RFID reader/writer of the wireless communication terminal 1, a power supply line 188 for supplying the power generated by the power generating circuit 184 from an antenna, a power supply select circuit 186, a power supply line 189 and a RF circuit 190 for executing the process such as converting between the analog signal transmitted to or received from an antenna and the digital signal processed by the controller. The power supply line 189 supplies power to the controller 181 and the nonvolatile memory 182.

According to a preferred embodiment, only the RFID 18 shown in FIG. 1 is operated of all the parts of the wireless communication terminal during the initialization. Specifically, during the initializing operation, the controller 11 is not operated and the controller 181 controls the initialization process. The initialization process for communication is executed in its entirety in the RFID 18, and the information thereof is recorded in the nonvolatile memory 182. The power for operation during the initialization is supplied from the power generating circuit 184.

During the normal operation, on the other hand, the controller 181 is not operated but the controller 11 works. In starting the communication as normal operation (by short-range radio), the controller 11 reads the following information used for the short-range wireless communication from the nonvolatile memory 182 of the RFID 18 through the serial interface 185. Specifically, the information to be read include the identification number of the base station and the encryption key for communication (shared with the base station 2 by the key exchange process 536 described later). As described above, during the initialization process, the RFID 18 is operated by the power supply 184, and during the normal operation, the entire wireless communication terminal 1 including the RFID 18 is operated by the power supply 16 (the RF circuit 190 is not operated). The aforementioned power supplies are switched by operating a switch 186 under the control of the controller 11. The base station 2 includes a controller 21, a short-range wireless interface 22, a RFID interface 23, a nonvolatile memory 24 and a communication interface 25.

The server 4 holds a list of identification numbers as an invalidation list 41 describing the invalidated wireless communication terminals. The contents of the invalidation list 41, though not specifically limited, include the identifiers of the wireless communication terminals lost by theft, loss, etc.

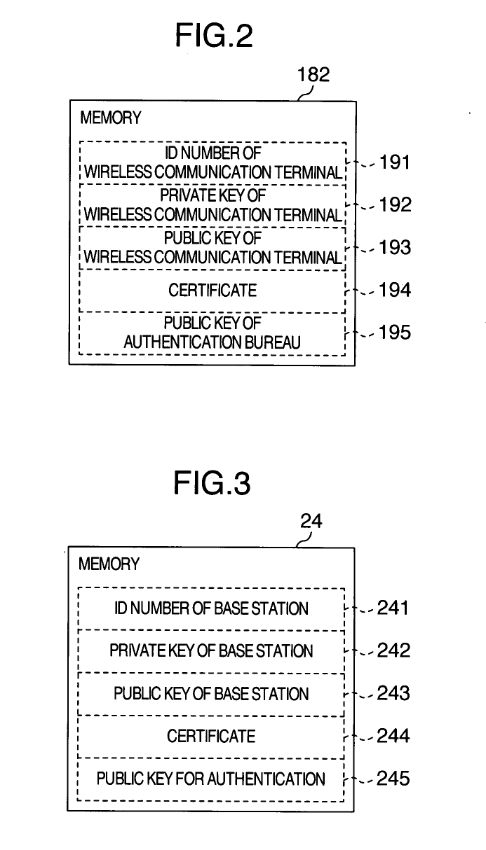

FIG. 2 is a diagram showing the information recorded in the nonvolatile memory 182 of the RFID 18 mounted on the wireless communication terminal 1.

FIG. 3 is a diagram showing the information recorded in the nonvolatile memory 24 of the base station 2.

The nonvolatile memory 182 of the RFID 18 contains the identification number 191 of the wireless communication terminal, the identification number 191 of the wireless communication terminal, the private key 192, the public key 193, the certificate 194 and the public key 195 of the certificate Authority. The nonvolatile memory 24 of the base station 2 contains the identification number 241 of the base station, the private key 242 of the base station, the public key 243 of the base station, the certificate 244 and the public key 245 of the certificate Authority. The authentication method using the public key cryptography is a well-known technique (Alfred J. Menezes, Paul C. van Oorschot, Scott A. Vanstone: “Handbook of Applied Cryptography”, CRC Press, 1996, ISBN: 0-8493-8523-7, Chapter 10), and therefore, not described in detail herein.

An example in which the information used for communication are stored in the nonvolatile memory 182 such as the flash memory (trade mark) is described above. In this example, power is not required to be supplied to the memory after the information is written in the memory. This leads to the advantage that the power consumption of the memory can be saved and the power supply is not required to be controlled. The configuration of the invention, however, is not limited to this, and the information can be stored also in any of other storage media such as a compact hard disk device and a volatile semiconductor memory. As an example, the information can be stored in a volatile memory such as the SRAM built in the controller 181. In this case, the volatile memory is required to be kept supplied with power. During the period when no power is supplied from the power generating circuit 184 of the RFID, therefore, power is required to be supplied by the power supply 16. This power supply switching operation can be controlled by the controller 181.

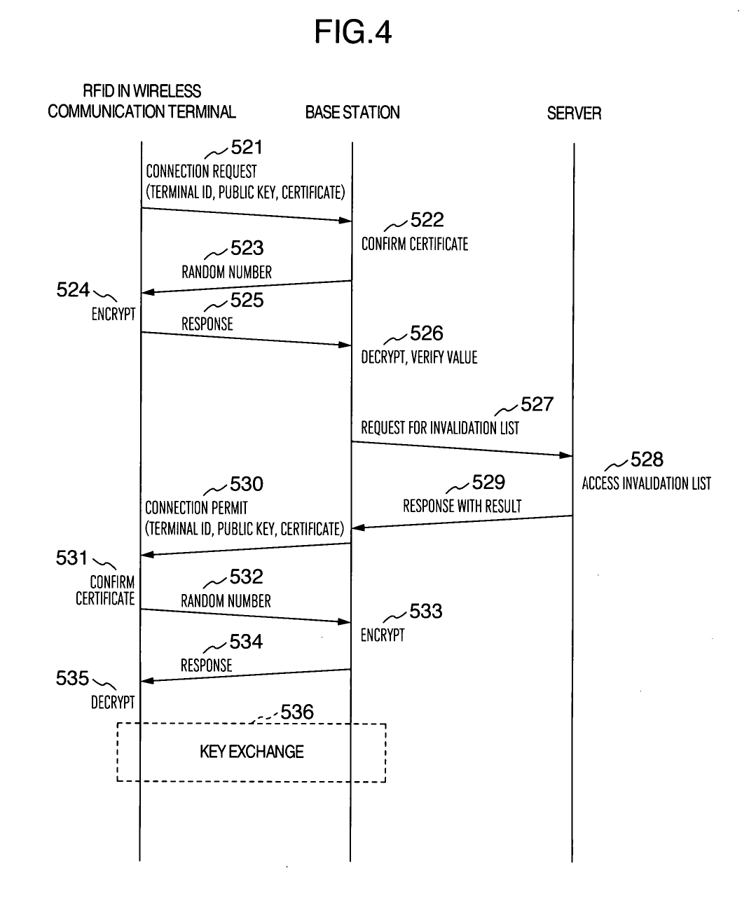

With reference to FIG. 4, the steps of the initialization process for communication between the wireless communication terminal 1 and the base station 2 is explained. The RFID 18 mounted on the wireless communication terminal 1, upon detection of the communicability by detecting the radio wave from the RFID of the base station, transmits a connection request message 521. The connection request message 521 contains the identification number 191 of the wireless communication terminal 1 read from the nonvolatile memory 182, the public key 193 and the certificate 194. The base station 2, upon receipt of the connection request message 521, executes the process 522 for confirming the certificate 194 using the public key 245 of the certificate Authority. Upon confirmation of the legitimacy of the certificate 194, the base station 2 transmits a random number 523 to the RFID 18. The controller 181 of the RFID 18 executes the encryption process 524 using the private key 192 for the random number 523, and prepares and transmits a response message 525 to the base station 2. The base station 2 decodes the response message 524 with the received public key 193 of the RFID, and checks to see whether it coincides with the original random number or not. In this way, the base station confirms whether the RFID of the other party of communication has the private key 192 or not. Next, the base station requests the server for an invalidation list (527), and the server, accessing (528) the invalidation list 41, transmits the result to the base station 2 (529). The request can use the identification number 191 transmitted from the RFID. The base station 2, upon confirmation that the RFID is not invalidated, transmits a connection permission message 530 to the RFID. The connection permission message 530 contains the identification number 241 of the base station, the public key 243 of the base station and the certificate 244. The RFID executes the process 531 for confirming the certificate 244 using the public key 195 of the certificate Authority. The RFID 18, upon confirmation of the legitimacy and validity of the certificate 244, transmits the random number 532 to the base station 2, which in turn executes the encryption process 533 using the private key 242 and returns a response message 534. The RFID performs the decode operation with the received public key 243 of the base station and checks whether it coincides with the original random number or not. In this way, the RFID confirms that the base station 2 constituting the other party of communication has the private key 242. Through the steps described above, the base station 2 and the RFID confirm the legitimacy of the other party of communication with each other. After that, the key exchange process 536 is executed, and the encryption keys 192, 242 for communication come to be shared by the base station 2 and the RFID 18. The method of execution of the key exchange process is a well-known technique (Douglass R. Stinson: “Cryptography: theory and practice”, CRC Press LLC, 1995, Chapter 8), and therefore, is not described in detail.

The process described above is executed by the communication through the RFID interface between the wireless communication terminal 1 and the base station 2. The power for this operation is generated by converting the signal (electromagnetic wave) supplied from the base station 2 through the power generating circuit 184, and the communication can be initialized without using the power supply 16 of the wireless communication terminal 1.

In the case where the distance between the place of installation of the wireless communication terminal and the base station is larger than the communicable distance of the RFID, the wireless communication terminal 1 is temporarily placed near the base station 2 during the initialization process, and after the initialization process, installed at the original place of installation, after which the communication is conducted with the base station by the short-range wireless communication. In this way, the method according to this invention can be implemented.

### Embodiment 2

Next, a second embodiment is explained with reference to FIGS. 1 and 5, 6, 7.

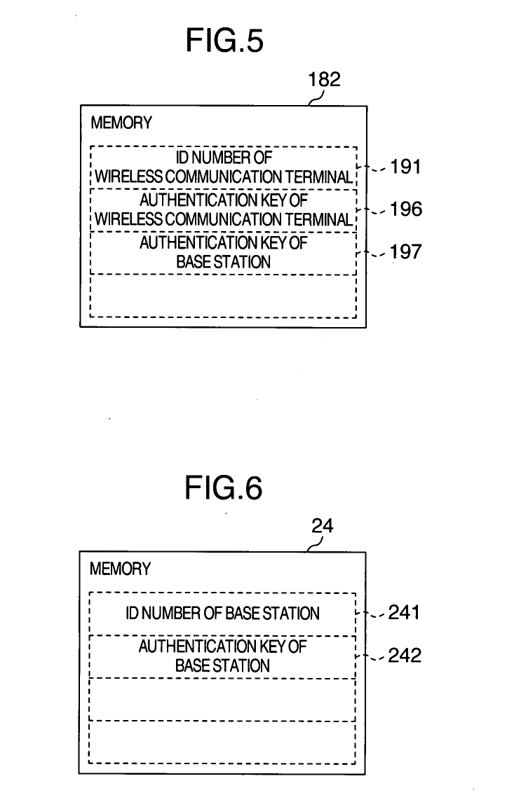

FIG. 5 is a diagram showing the contents recorded in the nonvolatile memory 12 in the RFID 18 mounted on the sensor node. The identification number 191 of the wireless communication terminal, the authentication key 196 of the wireless communication terminal and the authentication key 197 of the base station are recorded in the nonvolatile memory 182 in the RFID 18.

FIG. 6 is a diagram showing the contents recorded in the nonvolatile memory 24 of the base station 2. The identification number 241 of the base station and the authentication key 242 of the base station are recorded in the nonvolatile memory 24 of the base station 2.

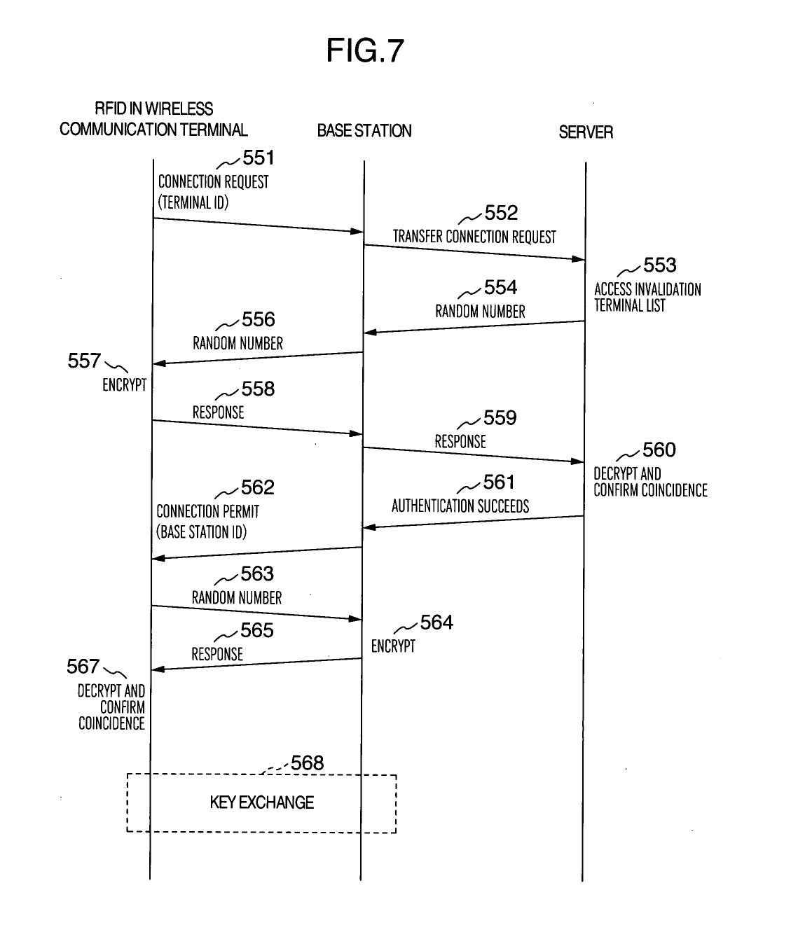

With reference to FIG. 7, the steps for initialization by communication through the RFID interface between the wireless communication terminal 1 and the base station 2 are explained below. The RFID 18 mounted on the wireless communication terminal 1, upon establishment of the physical communication by detecting the radio wave from the RFID of the base station, transmits a connection request message 551. The connection request message 551 contains the identification number 191 of the wireless communication terminal 1. The base station 2, upon receipt of the connection request message 551, transmits a connection request transfer message 552 to a server 4. The server 4, upon receipt of the connection request transfer message 552, accesses the terminal invalidation list 42 and checks to see whether the connection requesting terminal is valid or not (553). In the case where the connection requesting terminal is valid, the server 4 generates and transmits a random number to the base station (554). The base station 2 transmits the received random number to the wireless communication terminal 1 (556). The wireless communication terminal 1, using the authentication key 196 of itself, encrypts the received random number (557) and sends it to the base station 2 (558). The base station 2 sends the particular response to the server 4 (559), which in turn decodes the response using the authentication key of the wireless communication terminal held by itself, and checks to see that it coincides with the original random number thereby to authenticate the wireless communication terminal (560). Once the coincidence is confirmed and the authentication proves successful, the server 4 sends the authentication success message 561 to the base station 2, which in turn sends the connection permit message 562 to the wireless communication terminal 1. The wireless communication terminal 1, after receiving the connection permit message 562, makes the authentication to checks the legitimacy of the base station 2. For this purpose, the wireless communication terminal 1 generates and sends a random number to the base station 2 (563). The base station encrypts the random number using the base station authentication key 242 (564) of itself and transmits it to the wireless communication terminal 1 (565). The wireless communication terminal 567 decrypts the random number using the base station authentication key 197 recorded in the nonvolatile memory 182 thereby to check to see whether it coincides with the original random number or not. After that, the wireless communication terminal 1 and the base station 2 execute the process of exchanging the keys and thus come to share the encryption keys for communication. The method of the key exchange process 536 is a well-known technique and therefore not described in detail.

(Another Example of Configuration of Wireless Communication Terminal and Base Station)

Next, another example of the configuration of the wireless communication terminal and the base station according to the first and second embodiments of the invention are is explained.

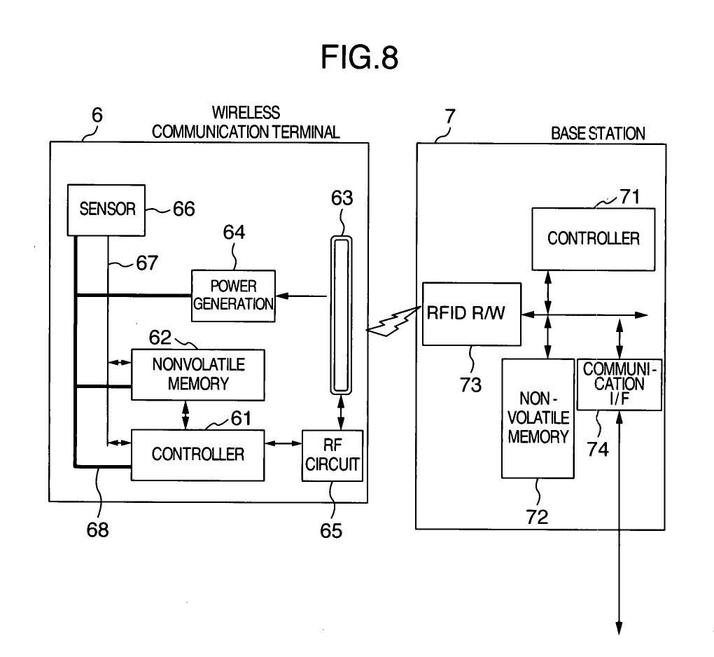

FIG. 8 is a diagram showing another example of the configuration of the wireless communication terminal and the base station. The wireless communication terminal 6 includes a controller 61, a nonvolatile memory 62 and a sensor 66, which are interconnected by an internal data bus 67. Further, the wireless communication terminal 1 includes a RFID antenna 63, a power generating circuit 64, a RF circuit 65 for executing such process as converting the analog signal transmitted/received through an antenna and the digital signal processed by the controller and a power supply line 68. The base station 7 includes a controller 71, a nonvolatile memory 72, a RFID interface 73 and a communication interface 74.

According to this embodiment, the initialization process between the wireless communication terminal and the base station is carried out similarly to the first or second embodiment. The communication between the wireless communication terminal and the base station after completion of the initialization process is conducted through the RFID interface. Each logic circuit and the sensor 66 of the wireless communication terminal 6 are supplied with the power generated by the power generating circuit 64.

### INDUSTRIAL APPLICABILITY

The invention according to the present application can be used for wireless communication terminals.

1. A wireless communication terminal used for a communication system configured of the wireless communication terminal, a base station and a server connected to the base station through a communication network, characterized in that:
the wireless communication terminal has mounted thereon a short-range wireless communication function for communication with the base station and a passive wireless tag; and
the process of configuring the communication between the wireless communication terminal and the base station is executed using the communication between the passive wireless tag mounted on the wireless communication terminal and the base station.

2. The wireless communication terminal according to claim 1, characterized in that the passive wireless tag has a storage medium, in which the identification number of the wireless communication terminal and the cryptographic key unique to the wireless communication terminal are recorded.

3. The wireless communication terminal according to claim 2, characterized in that the cryptographic key unique to the wireless communication terminal contains a public key, a private key and a certificate for authentication by the public key cryptosystem.

4. The wireless communication terminal according to claim 2, characterized in that the cryptographic key unique to the wireless communication terminal contains an encryption key according to the symmetric key cryptosystem.

5. The wireless communication terminal according to claim 1, characterized in that the wireless communication terminal contains a battery for supplying power at the time of operation, and the configuration process is activated by the passive wireless tag receiving power from the wireless tag reader/writer, while the power is supplied from the battery during the normal operation.

6. The wireless communication terminal according to claim 5, characterized in that the result of the configuration process is recorded in the storage medium, and during the normal operation, the communication is conducted by reading the result of the setting process from the storage medium.

7. The wireless communication terminal according to claim 6, characterized in that the storage medium is a nonvolatile storage medium arranged on the passive wireless tag.

8. In a communication system configured of a wireless communication terminal, a base station and a server connected to the base station through a communication network,
a control method characterized in that:
the wireless communication terminal has mounted thereon a short-range wireless communication function for communication with the base station and a passive wireless tag, and
the process of configuring the communication between the wireless communication terminal and the base station is executed using the communication between the passive wireless tag mounted on the wireless communication terminal and the base station.

9. The control method for the wireless communication system according to claim 8, characterized in that a storage medium is used, and the identification number of the wireless communication terminal and the cryptographic key unique to the wireless communication terminal are recorded in the storage medium.

10. The control method for the wireless communication system according to claim 9, characterized in that the cryptographic key unique to the wireless communication terminal contains the public key, the private key and the certificate for authentication according to the public key cryptosystem.

11. The control method for a wireless communication system according to claim 9, characterized in that the cryptographic key unique to the wireless communication terminal contains an encryption key according to the symmetric key cryptosystem.

12. The control method for a wireless communication system according to claim 9, characterized in that the nonvolatile storage medium of the passive wireless tag is used as the storage medium.

13. The control method for a wireless communication system according to claim 8, characterized in that the wireless communication terminal includes a battery for supplying power during the operation, and the configuration process is activated by the passive wireless tag receiving power from the reader/writer of the wireless tag, while during the normal operation, the power is supplied from the battery.

14. A base station for wireless communication in a radio communication system configured of a wireless communication terminal, a base station and a server connected to the base station through a communication network,
wherein the wireless communication terminal has a short-range wireless communication function for communication with the base station and a passive wireless tag, and
wherein the process of configuring the communication between the wireless communication terminal and the base station is executed using the communication between the passive wireless tag mounted on the wireless communication terminal and the base station;
characterized by comprising the wireless tag read/write function for communication with the passive wireless tag mounted on the wireless communication terminal.

15. A wireless communication terminal used for a communication system comprising the wireless communication terminal, a base station and a server connected to the base station through a communication network, wherein the wireless communication terminal includes:
a battery,
a controller,
a wireless interface,
a memory,
a RFID unit having an antenna and a power generating circuit for generating the power from the signal received by the antenna, and
an internal bus for connecting the first controller, the wireless interface and the memory;
characterized in that:
in the first mode, the controller is operated with the power generating circuit as a power supply, and the result of the operation is stored in the memory, and
in the second mode, the controller is operated with the power from the battery, and the communication is established with the base station through the wireless interface using the information stored in the memory.
